(19) United States
(12) Patent Application Publication
(10) Pub. No.: US 2025/0147233 A1
(43) Pub. Date: May 8, 2025

(54) OPTICAL TRANSCEIVER BANDWIDTH SCALING THROUGH DIRECT OPTICAL WIRE FIBER TERMINATION

(71) Applicant: Intel Corporation, Santa Clara, CA (US)

(72) Inventors: Junyi Qiu, Portland, OR (US); Mozhgan Mansuri, Portland, OR (US); Beom-Taek Lee, Beaverton, OR (US)

(73) Assignee: Intel Corporation, Santa Clara, CA (US)

(21) Appl. No.: 18/501,826

(22) Filed: Nov. 3, 2023

(51) Int. Cl. G02B 6/12; H04J 14/02

(52) U.S. Cl. CPC G02B 6/12011; G02B 6/12004; H04J 14/021; H04J 14/0221

(57) ABSTRACT

A wavelength multiplexing optical fiber transmitter, receiver, or transceiver where multiple emitters and/or photodetectors of different center wavelengths are coupled to a single optical fiber core terminus through multiple waveguides, which may be directly printed in free space. The optical assemblies described are suitable for optical data link applications, for example, to reduce a number of optical fibers needed for a given bandwidth or increase the bandwidth of a give number of optical fibers. Bidirectional fiber termination may also be implemented with an emitter and a photodetector pair coupled to a single optical fiber core terminus through multiple waveguides.

### BACKGROUND

The scalability challenges electrical interconnects face for longer reaches (e.g., 1 m or longer) may be addressed with optical data links due to their potential for negligible frequency dependent losses. Optical links based on vertical cavity surface-emitting laser (VCSEL) emitters are now commercially available. However, it remains challenging to meet ever-increasing bandwidth demands while maintaining high energy efficiency, a small device footprint, and low cost.

For a given optical data link, an aggregate data rate can be expressed by a data rate per lane multiplied by the number of wavelengths multiplexed onto an optical fiber, further multiplied by the number of optical fibers in the link. Strategies to increase optical link data rates have included increasing the data rate per lane by increasing emitter bandwidth (e.g., from a few GHz to up to 30 GHz, or more) and/or by implementing non-to-return-zero (NRZ) data transmission or pulse-amplitude modulation (PAM4). Strategies to increase optical link data rates have also included utilizing wavelength division multiplexing (WDM) where emitters with different wavelengths launch their modulated lights into a single optical fiber. Strategies to increase optical link data rates have also included increasing the number of fibers and/or fiber cores. For example, multiplexing and additions have progressed transceiver standards from 4 data lanes and 8 fibers (e.g., where one fiber transmits, and another fiber receives) to 8 or 16 data lanes.

However, these strategies toward higher bandwidth have disadvantages. Further increasing data rate per lane may be limited by the device physics of emitter modulation. Raw bit-error-rate (BER) and energy efficiency also degrade with higher order modulation such as PAM4. For WDM, an optical multiplexer/demultiplexer (mux/demux) is needed between each fiber terminus and an array of emitters or photodetectors (PDs). Many of these mux/demux architectures currently rely on a complex mechanical-optical interface (MOI) having wavelength filters and one or more integrated micro lenses, which may become cost-prohibitive. Also, mux/demux architectures have a high package profile (i.e., z-height) and/or a large footprint that can preclude their close integration within a photonic integrated circuit (PIC) system, which is key for bandwidth scalability. Finally, simply adding more lanes/fibers in parallel does not increase the per-fiber or per-area bandwidth density of an optical link. Currently, fiber array pitch size is limited by fiber diameter (e.g., 127 μm pitch for multi-mode fiber with standard 125 μm diameter cladding). The shoreline fiber density is therefore very difficult to scale.

Accordingly, device architectures capable of multiplexing an optical fiber within a smaller footprint, and/or lower profile that enables multiplexed optical fibers to be closely integrated within a system (e.g., within a PIC package), and at potentially lower cost than conventional solutions, are commercially advantageous. Device architectures capable of improving shoreline bandwidth density would also be commercially advantageous.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a flow diagram of methods for assembling optical devices multiplexed through optical wire fiber termination, in accordance with some embodiments;

FIG. 2A is a cross-sectional profile view of a photonic device assembly including multiplexed optical wire fiber termination, in accordance with some embodiments;

FIG. 2B is a cross-sectional profile view of an optical fiber end face and two optical wires overlapping different portions of the fiber end face, in accordance with some embodiments;

FIG. 3 is a schematic of an optical fiber multiplexing system including an optical fiber array and a plurality of optical devices coupled through optical wires to each of a plurality of optical fibers, in accordance with some embodiments;

FIGS. 4A, 4B, 4C and 4D illustrate a cross-sectional profile view of an optical fiber core end face and a plurality of optical wires overlapping different portions of the fiber core end face, in accordance with some embodiments;

FIG. 5 is a schematic illustrating an optical wire extending from an optical emitter to a fiber core end face, in accordance with some embodiments;

FIGS. 6A and 6B are schematics illustrating an optical wire extending from an optical detector to a fiber core end face, in accordance with some embodiments;

FIG. 7A is a cross-sectional profile view of a bidirectional optical fiber multiplexing system, in accordance with some embodiments;

FIG. 7B is a cross-sectional view through a first optical fiber end face of the multiplexing system illustrated in FIG. 7A, in accordance with some embodiments;

FIG. 7C is a cross-sectional view through a second optical fiber end face of the multiplexing system illustrated in FIG. 7A, in accordance with some embodiments;

FIG. 8 illustrates a mobile computing platform and a data server machine comprising multiplexed optical wire fiber termination, in accordance with some embodiments; and

FIG. 9 is a functional block diagram of an electronic computing device, that may implement one or more of the components of the mobile platform or data serve machine illustrated in FIG. 8, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

As previously noted, an optical data link may advantageously comprise a plurality of transmitters (Tx) with a plurality of emitters that are functional as a multi-wavelength (multi-channel) source. An optical data link may similarly comprise a plurality of receivers (Rx) with a plurality of photodetectors that are functional as a multi-wavelength (multi-channel) sink. As described further below, a transmitter in accordance with embodiments herein may multiplex a single optical fiber to a plurality of emitters, or a plurality of detectors, or to emitter/detector transceiver pairs, through a plurality of optical wires. Each of the optical wires is an optical waveguide that can propagate optical modes to/from a single terminus of an optical fiber core to a plurality of optical devices. The optical wires may be of a polymer composition that can be directly (3D) printed in free space as part of an assembly process.

The multiplexed optical fiber coupling architectures described herein can avoid limitations associated with free space propagation, for example eliminating the need for collimation and focusing to compensate for device/air or fiber/air interfaces. The multiplexed optical fiber coupling architectures described herein can also avoid the use of reflectors to steer light between optical device apertures and a fiber core. Fine alignment between an optical device aperture relative and a fiber core can also be avoided, allowing more freedom in arranging optical device arrays. Furthermore, a more compact optical fiber termination assembly may be achieved, with each optical path readily accessible.

In accordance with exemplary embodiments, Tx, Rx, and/or Tx/Rx architectures in accordance with embodiments herein are advantageously implemented with one or more photonic integrated circuits (PICs). Although many examples herein are therefore further described in the context of PIC implementations, the exemplary optical fiber multiplexing architectures may instead be implemented in alternative technologies without departing from the principles disclosed herein.

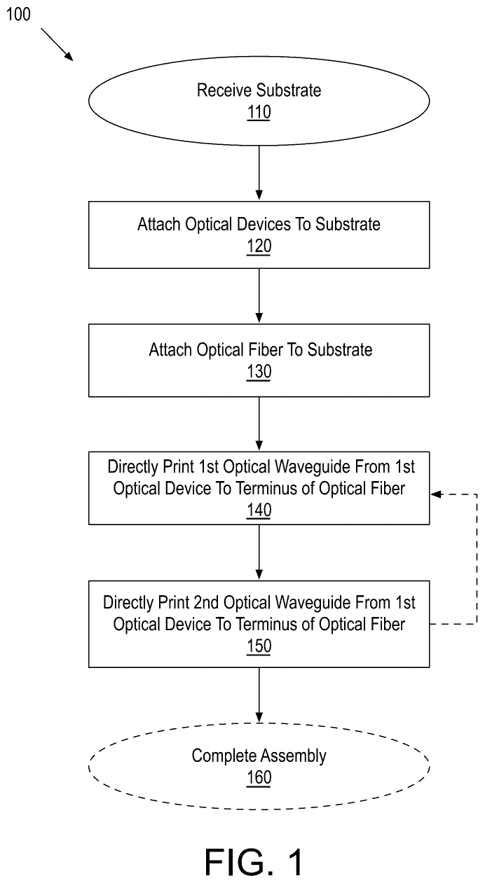

FIG. 1 illustrates a flow diagram of methods 100 for assembling optical devices multiplexed through direct optical wire fiber termination, in accordance with some embodiments. Methods 100 begin at input 110 where a workpiece comprising a suitable substrate is received as an input. In some examples, methods 100 are practiced on a workpiece comprising a PIC chip. The PIC chip may be the substrate, or the PIC chip may have been previously assembled upon a package substrate that is received at input 110. In other embodiments, a PIC chip has not yet been assembled to the package substrate received at input 110 and methods 100 may be completed prior to further assembling a PIC chip to the package substrate. In some embodiments, methods 100 are practiced upon in a single (e.g., first) substrate. However, in some alternative implementations, some blocks of methods 100 may be practiced on a first substrate while other blocks are practiced on a second substrate. The multiple substrates may then be assembled with another (third) substrate and a remainder of the blocks of methods 100 completed.

At block 120, a plurality of optical devices is attached to a substrate. Each optical device may be any optical device suitable for coupling with an optical fiber. In exemplary embodiments, the optical devices attached at block 120 are one or more of an optical emitter or an optical (photo) detector. However, other optical devices, such as array waveguide gratings (AWG), optical modulators, or the like, may be similarly attached to a substrate at block 120. Any means of attachment known to be suitable for a particular optical device and substrate combination may be practiced at block 120 as embodiments are unlimited in this respect. In some examples, semiconductor light emitters and/or semiconductor photodetectors are attached with surface mount technology.

Methods 100 continue at block 130 where one or more optical fibers are attached to the substrate. The optical fiber may be any known to be suitable for integration with the optical devices attached at block 120. In some examples, a multi-mode (MM) fiber core having any suitable composition (e.g., a glass media) is attached to the substrate, for example adjacent to the optical devices assembled at block 120. The fiber core may be affixed to the substrate with any techniques and/or structures known to be suitable for the fiber core and the substrate combination as embodiments are unlimited in this respect. Along with the fiber core, an optical fiber may include and inner and/or outer cladding, which may also be attached to the substrate at block 130. No order is implied by the numbering of blocks 120 and 130 as optical fibers and optical devices may be attached according to any sequence.

Methods 100 continue at block 140 where a first optical waveguide or ‘optical wire’ is directly printed to span a distance between a first of the optical devices assembled at block 120 and a first portion of the terminal surface area of the optical fiber attached at block 130. In contrast to a planar, slab, rib, ridge, or channel optical waveguide, which all comprise some planar portion of substrate material, an optical wire is a non-planar optical waveguide spanning a distance above, or “off” of an underlying substrate. As a non-planar waveguide, an optical wire may be freely suspended above the substrate. In contrast to an optical fiber waveguide drawn from glass, an optical wire is advantageously printed with a material other than glass, such as a polymer. Similar to an electrical bond wire, an optical wire in accordance with embodiments herein is a point-to-point

Optical wire printing may progress by building up the wire material either from a surface of the assembled optical device or from a surface of a fiber terminus. Wire printing may proceed by controlling a free-space translation of a printhead that comprises a micropipette through which a polymer precursor solution is transported and/or extruded to form a meniscus where solvent from the polymer precursor solution is evaporated at a rate controlled to match translation of the printhead. With evaporation of the solvent, dissolved polymer precursor material solidifies (e.g., crosslinks) to form a solid polymer material (e.g., having a circular cross-sectional shape).

Methods 100 continue at block 150 where a second optical waveguide or ‘optical wire’ is directly printed to span a distance between a second of the optical devices assembled at block 120 and a second portion of the terminus of the optical fiber attached at block 130. Substantially the same optical wire printing process practiced at block 140 may be repeated at block 150 and may progress by building up the wire material either from a surface of the optical device or from the surface of the fiber terminus.

Blocks 140 and 150 may be iterated any number of times for a single optical fiber to fabricate any number of connections to the same optical fiber thereby optically multiplexing the fiber to either many inputs (e.g., emitters), many outputs (e.g., detectors), or bidirectional I/O pairs (e.g., an emitter-detector pair). Methods 100 may further iterate through blocks 140 and 150 any number of times to directly print optical wires to each of all the optical fibers attached a block 130. Methods 100 then complete at output 160 where a photonic device assembly is completed, for example according to any known techniques.

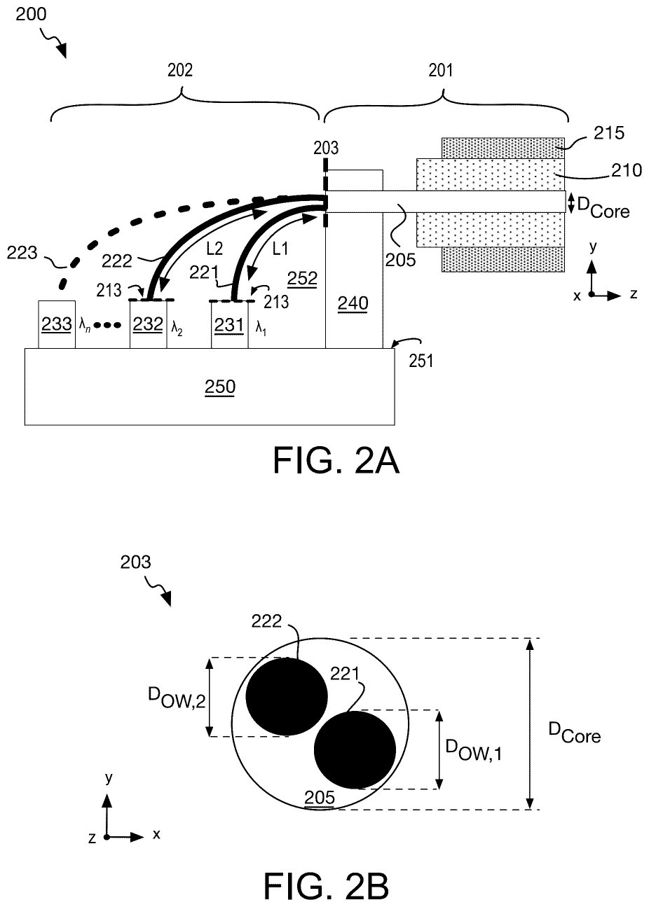

FIG. 2A is a cross-sectional profile view of a photonic device assembly 200 including an optical fiber length 201 coupled through multiplexed optical wire fiber termination 202 to a plurality of optical devices 231-233, in accordance with some embodiments. In exemplary embodiments photonic device assembly 200 is fabricated by practicing methods 100 (FIG. 1). However, photonic device assembly 200 (FIG. 2A) may also be fabricated according to alternative methods.

Photonic device assembly 200 includes a plurality of optical devices attached to a surface 251 of a substrate 250. Surface 251 may be substantially planar (e.g., a reference x-z plane), for example. Substrate 250 may be any substrate suitable for physical assembly of an optical data link. In exemplary embodiments, substrate 250 is a PIC package substrate. A package substrate may include one or more materials such as an epoxy preform, cored or coreless laminate board, a substantially homogenous bulk glass, or a monocrystalline silicon substrate. Substrate 250 may include one or more metallized redistribution levels (not depicted) embedded within a dielectric material. Substrate may also include one or more IC die (not depicted) embedded therein. In some exemplary embodiments, substrate 250 is a printed circuit board (PCB) comprising a composite such as FR4.

Photonic device assembly 200 includes at least two optical devices 231 and 232, but may include any number of additional optical devices 233. Optical devices 231-233 may be attached to substrate 250 according to any suitable technique. In some examples, optical devices 231, 232 are surface mounted, for example with solder interconnects. Optical devices 231-233 may also be directly bonded to substrate 250, or may be monolithically integrated into substrate 250. Each of optical devices 231-233 may be any optical device suitable for fiber coupling, such as emitters, photodetectors, electro-optic modulators, acousto-optic modulators, or arrayed waveguide gratings (AWGs). Optical devices 231-233 are illustrated as vertical devices with an aperture substantially parallel to the x-z plane of substrate 250. However, optical devices 231-233 may also have an edge/facet coupled architecture.

In some exemplary embodiments, at least one of optical devices 231, 232 is an emitter. Emitters in accordance with embodiments may emit radiation at any center wavelength (λ), but in some examples emit over the IR band of the electromagnetic spectrum and, more specifically, the near IR band of 850 nm-940 nm. In some exemplary embodiments, at least one of optical devices 231, 232 comprises a laser diode. For the illustrated vertical emission embodiments, at least one of optical devices 231, 232 is a VCSEL. In other embodiments, at least one of optical devices 231, 232 is a light emitting diode (LED), and more specifically a μLED.

In some embodiments, both of optical devices 231 and 232 are emitters. Although both emitters may emit at a same center wavelength, in some exemplary wavelength division multiplexed (WDM) embodiments, optical device 231 emits at a first center wavelength (λ₁) and optical device 232 emits at a second center wavelength (λ₂). In some embodiments, λ₁ differs from λ₂ by at least 1 nm, and advantageously by at least 5 nm, or more. In some exemplary near IR band embodiments, λ₁ is approximately 850 nm and λ₂ is approximately 880 nm (i.e., a 30 nm difference between λ₁ and λ₂). For such embodiments, additional optical devices 233 may similarly emit other center wavelengths, for example all separated by approximately 30 nm.

In some other embodiments, both of optical devices 231 and 232 are photodetectors. The photodetectors may have any semiconductor architecture, such as a p-n photodiode, p-i-n photodetector, Schottky barrier photodetector, or metal-semiconductor-metal (MSM) photodetector. The photodetectors may have broadband responsivity or may have narrowband responsivity (e.g., a resonant-cavity-enhanced architecture). Although both optical devices 231 and 232 may have responsivity tuned to a same center wavelength, in some exemplary wavelength division multiplexed (WDM) embodiments, optical device 231 has a peak responsivity at a first center wavelength (λ₁) and optical device 232 has a peak responsivity at a second center wavelength (λ₂). In some embodiments, λ₁ differs from λ₂ by at least 1 nm, and advantageously by at least 5 nm, or more. In some exemplary near IR band embodiments, λ₁ is approximately 850 nm and λ₂ is approximately 880 nm (i.e., a 30 nm difference between λ₁ and λ₂). For such embodiments, additional optical devices 233 may similarly have peak responsivity at other center wavelengths, for example all separated by approximately 30 nm. In some broadband detector embodiments, one or more of optical devices 231 and 232 comprise a wavelength filter suitable for imparting λ₁ and λ₂ wavelength selectivity to optical devices 231 and 232, respectively. In some narrowband detector embodiments, one or more of optical devices 231 and 232 comprise a resonant cavity tuned for peak absorption at λ₁ and λ₂, respectively.

In still other embodiments, a first optical device (e.g., 231) is a photodetector and a second optical devices (e.g., 232) is an emitter. The first and second optical devices may, for example, comprise a pairing of receiver and transmitter devices that are advantageously operable together as a bidirectional transceiver of an I/O channel. For such embodiments, the first optical device (e.g., 231) may have responsivity over one or more center wavelengths (e.g., λ₁ and/or λ₂) and the second optical device (e.g., 232) may emit over a same or different center wavelength (e.g., λ₂ and/or λ₁).

Optical fiber length 201 comprises a core 205. Although a double clad fiber embodiment is illustrated, fiber length 201 may have any number of cladding layers (e.g., single, triple, etc.) known to be suitable for optical fiber waveguides. In the example illustrated in FIG. 2A, fiber length 201 has an inner cladding 210, which is annular and encompasses core 205. An annular outer cladding 215 surrounds inner cladding 210. Fiber core 205 is axially surrounded by an inner cladding 210. Inner cladding 210 is axially surrounded by an outer cladding 215. Although core 205 and inner cladding 210 are illustrated as being concentric (i.e., a centered core), they need not be. One or more of core 205 and cladding 210 may also be a variety of shapes other than circular, such as, but not limited to annular, elliptical, or irregular. Although core 205 and inner cladding 210 are illustrated as co-axial, they may alternatively have axes offset with respect to one another.

Core 205 may have any suitable composition, but in exemplary embodiments is of a glass suitable for IR-band transmission. The glass may be SiO₂, SiO₂ doped with GeO₂, germanosilicate, phosphorus pentoxide, phosphosilicate, Al₂O₃, aluminosilicate, or the like, or any combinations thereof. Inner cladding 210 may also be of a glass having sufficient index contrast with core 205 to sustain internal reflection of one or more guided optical core modes. Outer cladding 215 may be a polymer or another glass, for example. Although not depicted, one or more protective (non-optical) coatings may further surround outer cladding 215.

In accordance with some embodiments, core 205 is a multi-mode (MM) core suitable for propagation of multiple core modes. With sufficient core diameter D_{core}, fiber length 201 supports the propagation of more than one transverse optical mode (e.g., LP₀₁, LP₀₂, LP₁₁, etc.). In exemplary MM embodiments, D_{core} is approximately 50 μm (e.g., OM3 or OM4 of ISO/IEC 11801). In alternative MM embodiments, D_{core} is approximately 62 μm (e.g., OM1 of ISO/IEC 11801). In accordance with other embodiments, core 205 is a single-mode (SM) core suitable for the propagation of only one transverse optical mode (e.g., LP₀₁). In exemplary SM embodiments, D core is less than 10 μm (e.g., ˜9 μm).

As illustrated, optical fiber length 201 extends in an axial (e.g., z) dimension within an x-y plane that is substantially parallel to an x-z plane of substrate 250. A terminal end length of fiber core 205 is embedded within a fiber array unit 240 that is physically attached to a surface of another region of substrate 250, laterally adjacent to optical devices 231-233. Fiber array unit 240 may comprise any structural material suitable for anchoring fiber core 205 to substrate 250 while maintaining optical confinement within core 205. Fiber array unit 240 may comprise a bottom plate attached to substrate 250. The bottom plate may have a v-groove to accept and orient one fiber core 205. Fiber array unit 240 may further comprise a top plate that is bonded to the bottom plate with fiber core 205 embedded between the plates. The top and bottom plates may be a glass, for example with lower refractive index than that of core 205. One or more glues may adhere the plates of fiber array unit 240. Although only one fiber core 205 is illustrated in the cross-sectional profile view of FIG. 2A, fiber array unit 240 may include any number of fiber cores, for example spaced apart over substrate 250 within the x-dimension.

Fiber array unit 240 and fiber core 205 may be ground and/or polished to have a fiber end face 203 with sufficient flatness and a suitable angle relative to the y-axis. Although a dashed line demarks fiber end face 203 to be on an x-y plane perpendicular to the fiber axial length (i.e., a 0° face angle), fiber end face 203 may be at other angles (e.g., <10° face angle, etc.).

As further illustrated in FIG. 2A, multiplexed optical wire fiber termination 202 comprises an optical wire 221 spanning a wire length L1 between a first portion of fiber end face 203 and an aperture of optical device 231 and substantially free from contact with substrate 250. An entirety of optical wire length L1 is illustrated as freely suspended above, or over, substrate 250 to emphasize the presence of a gap 252 between substrate surface 251 and optical wire 221. Nevertheless, some contact between an optical wire and substrate 250 may occur in some implementations. Being at least partially stood-off from substrate surface 251 in a manner similar to an electrical bond wire, optical wire 221 is an optical waveguide that is structurally distinguishable from a planar optical waveguide, which is confined to substrate 250 in a manner more analogous to an electrical trace than an electrical bond wire. Notably, gap 252 may be backfilled with any intervening material (not depicted) that maintains an adequate index contrast with optical wire 221.

Fiber termination 202 comprises another optical wire 222 spanning another length L2 between a second portion of fiber end face 203 and an aperture of optical device 232 and likewise substantially free from contact with substrate 250. Although optical wire 222 is illustrated as being freely suspended above or over substrate 250 over an entirety of length L2, some contact to substrate surface 251 may occur. Nevertheless, optical wire 22 is again distinguishable from a planar optical waveguide confined to a portion of substrate 250. For any additional optical devices 233, other optical wires 223 similarly span the length or distance between the optical device and another portion of fiber end face 203. Additional optical wires 223 are illustrated in dashed line to emphasize they are optional and there may be any number of such additional optical wires.

Optical wires 221-223 are waveguides to propagate one or more optical modes to/from fiber end face 203 to apertures of optical devices 231-233. In exemplary embodiments, optical wires 221-223 have a composition distinct from fiber core 205. For example, optical wires 221-223 may be other than glass, and instead comprise one or more materials of a suitably high refractive index. Optical wires 221-223 may be of a material derived from a precursor solution dispensed by direct printing processes described in methods 100 (FIG. 1). Optical wires 221-223 may be printed, for example, following attachment of optical devices 231-233 and attachment of fiber array unit 240.

In some embodiments, optical wires 221-223 all have substantially the same chemical composition. Each of optical wires 221-223 may advantageously be a polymer material. In some embodiments, the polymer material comprises one or more organic compounds. The polymer material may, for example, comprise polystyrene, methyl polymethacrylate, polycarbonate, perfluorinated compounds (PFCs) such as amorphous fluoropolymers. The polymer material may also comprise polyimides, epoxy compounds such as SU-8, or optoelectronic n-conjugated polymers (CP). Each optical wire 221-223 may be substantially homogenous in composition. Each optical wire 221-223 may be surrounded by free-space (e.g., air), or may be embedded within one or more cladding or coating materials (not depicted).

As shown in FIG. 2A, optical wires 221-222 optically couple the vertically oriented (i.e., vertical coupling) emission and/or collection aperture with the horizontally oriented (i.e., edge coupling) fiber end face 203. A first end of optical wire 221 is in direct contact with an aperture of optical device 231. In some embodiments, optical wire 221 is in direct contact with a thin film optical filter material 213. Optical properties of filter material 213 may differ between optical device 231 and 232, for example to render a first photodetector (e.g., device 231) most responsive to a first radiation band and a second photodetector (e.g., device 232) most responsive to a second radiation band. In the illustrated embodiments, a second end of optical wire 221 is in direct contact with a portion of fiber end face 203. Although end face attachment is illustrated as an advantageous embodiment, the second end of optical wire 221 may alternatively interface fiber core 205 over some axial length of the fiber core 205, for example through an evanescent wave coupler. A first end of optical wire 222 is in direct contact with an aperture of optical device 232 while a second end of optical wire 222 is in direct contact with another portion of fiber end face 203. Although the illustrated end face attachment is advantageous, the second end of optical wire 222 may alternatively interface fiber core 205 over some axial length of the fiber core 205 (e.g., for example through an evanescent wave coupler).

FIG. 2B is a cross-sectional profile view of optical fiber end face 203, in accordance with some embodiments. As shown, cross sectional areas of optical wires 221 and 222 overlap different portions of an area of fiber core 205. Optical wire 221 has a cross-sectional area associated with wire diameter D_{w,1}, which is smaller than the sectional area associated with core diameter D_{Core} by an amount sufficient to permit the cross-sectional area of optical wire 221 associated with wire diameter D_{w,2} to further overlap another region of optical fiber core end face 203. Although not depicted in FIG. 2B, if additional optical wires are to overlap fiber core end face 203, the optical wire diameters may be scaled to make room for the greater number of wire-fiber interfaces. In the embodiment illustrated in FIG. 2B, optical wires 221 and 222 have substantially circular cross-sections. However, optical wires may have other cross-sectional shapes at their interface with fiber end face 203.

In some embodiments, optical wires 221 and 222 have a wire diameter that is no more than half that of fiber core 205. In some examples where core diameter D_{Core} is approximately 50 μm, wire diameters D_{w,1} and D_{w,2} are 10-20 μm. In other embodiments where core diameter D_{Core} is 9-10 μm, wire diameters D_{w,1} and D_{w,2} are 1-3 μm. Submicron wire diameters are also possible. Wire diameters D_{w,1} and D_{w,2} may be substantially equal. For example, where optical devices 231 and 232 are both emitters or both photodetectors, D_{w,1} and D_{w,2} may be substantially equal. Wire diameter D_{w,1} may also be significantly different from wire diameter D_{w,2} (e.g., varying by 30%, or more). For example, where optical device 231 is a photodetector and optical device 232 is an emitter, wire diameter D_{w,1} may be 30-300% larger than wire diameter D_{w,2}.

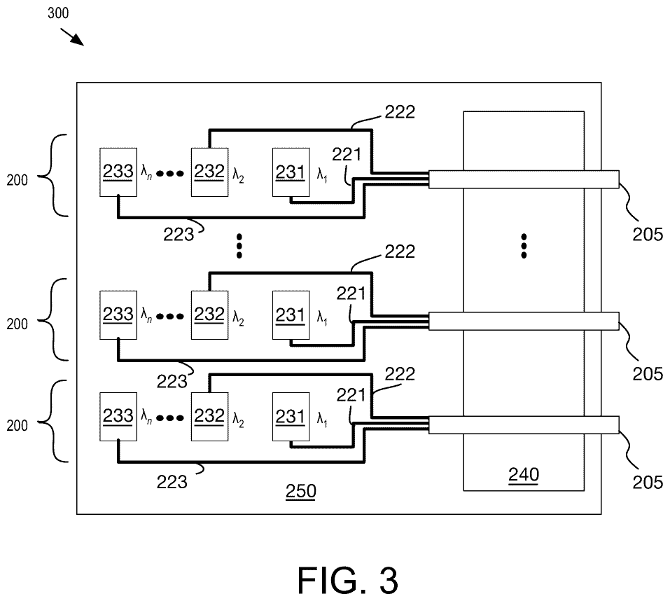

A photonic device assembly may include any number of optical fibers having the multiplexed optical wire fiber termination implemented on each of the optical fibers. FIG. 3 is a schematic of a fiber multiplexing system 300 including a plurality (e.g., an integer number M) of optical devices 231-233 coupled through optical wire fiber termination to each of a plurality (e.g., an integer number N) of optical fibers 205, in accordance with some embodiments. As shown, fiber multiplexing system 300 comprises a plurality (e.g., an integer number N) of photonic device assemblies 200 with each photonic device assembly 200 being substantially as described above. In this example, a set of optical wires 221-223 terminate each optical fiber core 205 to one of optical devices 231-233. Accordingly, a WDM transmitter and/or receiver spanning a center wavelength range of λ₁-λₙ may be implemented on each of any number of optical fibers 205.

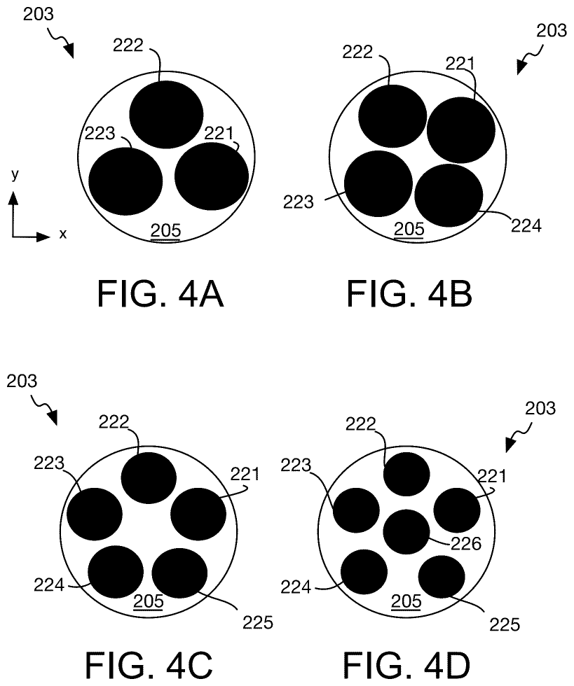

As noted above, optical wire fiber termination may multiplex an optical fiber to any number of optical devices. FIG. 4A-4D illustrate a cross-sectional profile views of an optical fiber end face and a plurality of optical wires overlapping separate portions of the fiber core end face, in accordance with embodiments having different optical wire counts. FIG. 4A illustrates three different portions of fiber core end face 203 terminated by three cross-sections associated with three optical wires 221-223. FIG. 4B illustrates four different portions of fiber core end face 203 terminated by four cross-sections associated with four optical wires 221-224. FIG. 4C illustrates five different portions of fiber core end face 203 terminated by five cross-sections associated with five optical wires 221-225. FIG. 4D illustrates six different portions of fiber core end face 203 terminated by six cross-sections associated with six optical wires 221-226. Although not depicted, 8, 16, 32, or even 64 optical wires may similarly terminate an optical fiber as a function of the fiber core diameter and optical wire diameter(s).

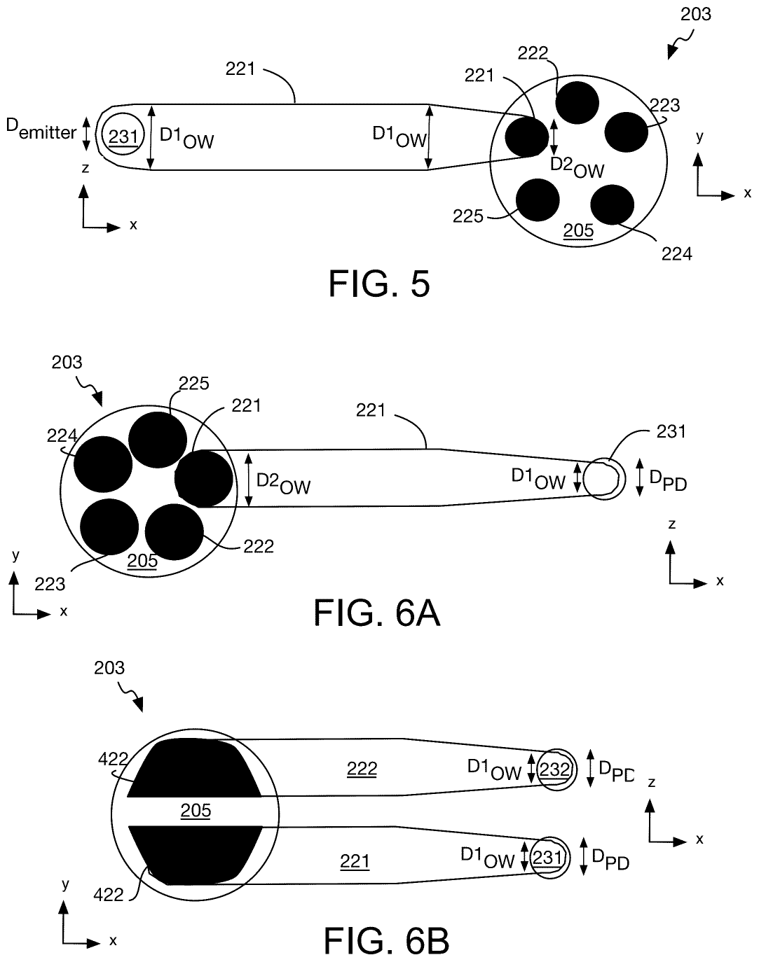

Optical wires in accordance with embodiments herein may maintain a substantially constant cross-section between an optical fiber end face and an optical device aperture, or the cross-section of an optical wire may vary significantly in shape and/or size between two endpoints of the optical wire. FIG. 5 is a schematic illustrating an optical wire extending from an optical emitter to a fiber core end face, in accordance with some embodiments. In FIG. 5, a plan view corresponding to the x-z plane of FIG. 2 is shown for a first end of optical wire 221 that intersects optical device 231. FIG. 5 further illustrates a plan view corresponding to the x-y plane of FIG. 2 for a second end of optical wire 221 that intersects optical fiber end face 203.

FIG. 5 illustrates some exemplary embodiments where optical device 231 is an emitter. Optical wire 221 has a first wire diameter Dlow that is advantageously somewhat larger than an emission aperture diameter Dₑₘᵢₜₜₑᵣ to efficiently couple light from the emitter. For VCSEL embodiments having an emission aperture diameter Dₑₘᵢₜₜₑᵣ of approximately 10 μm, wire diameter Dlow may be approximately 15 μm, for example. Optical wire 221 may maintain the first wire diameter Dlow, over an entirety of its length, it which case it is feasible for 2-6 such wires to interface to a fiber end face 203 having a 50 μm diameter. Even more emitter-coupled optical wires may be multiplexed to fiber end face 203 for embodiments where the wire diameter tapers down to a second wire diameter D2ow at fiber end face 203. Wire diameter D2ow may be selected to have an overlap area that enables all other optical devices multiplexed to fiber end face 203 to have a similarly dimensioned area of interface with fiber end face 203 assuming that area is sufficient to launch light into fiber core 205 with adequate power for a given WDM application.

FIG. 6A is schematic illustrating exemplary embodiments where optical device 231 is a photodetector. In FIG. 6A, a plan view corresponding to the x-z plane of FIG. 2 is shown for a first end of optical wire 221 that intersects optical device 231. FIG. 6A further illustrates a plan view corresponding to the x-y plane of FIG. 2 for a second end of optical wire 221 that intersects optical fiber end face 203. As shown, optical wire 221 has a first wire diameter Dlow that is advantageously somewhat smaller than a collection aperture diameter D_{PD} to efficiently couple light into the photodetector. As one example, for some PD embodiments having a collection aperture diameter D_{PD} of 20-30 μm, wire diameter Dlow may be 10-20 μm. Optical wire 221 may maintain the first wire diameter Dlow, over an entirety of its length, in which case it is again feasible for 2-6 such wires to interface to a fiber end face 203 having a 50 μm diameter. However, a certain degree of coupling loss can be expected at the interface of end face 203 and optical wire 221, for example because of area mismatch. However, as illustrated in FIG. 6A, optical wire 221 may taper up from wire diameter Dlow to reach a larger second wire diameter D2ow at fiber end face 203. Diameter D2ow may be maximized for a given number of photodetectors being multiplexed to fiber end face 203 with larger diameters suffering less coupling loss. Hence, comparing FIG. 6A to FIG. 5, D2ow may be advantageously larger for detector multiplexing than for emitter multiplexing.

In some embodiments, at least a partial length of at least some optical wires employed to multiplex an optical fiber have a non-circular cross-section. Optical wires of arbitrary cross-sectional shape may be directly printed in substantially the same manner as a those of circular cross-section. Indeed, an optical wire may have a substantially circular cross-section at a first end, and transitions to a non-circular cross-sectional proximal to a second end of the wire. Such variations in cross-sectional shape may also be combined with variations in cross-sectional area.

FIG. 6B is schematic illustrating exemplary embodiments where optical device 231 and 232 are both photodetectors. In FIG. 6B, a plan view corresponding to the x-z plane of FIG. 2 is shown for a first end of optical wires 221, 222 that intersect optical device 231. FIG. 6B illustrates how two multiplexed optical wires 221, 222 taper from circular cross-sections associated with diameter Dlow to non-circular polygonal cross-sections 422 having areas maximized for one pair of wires confined to fiber end face 203.

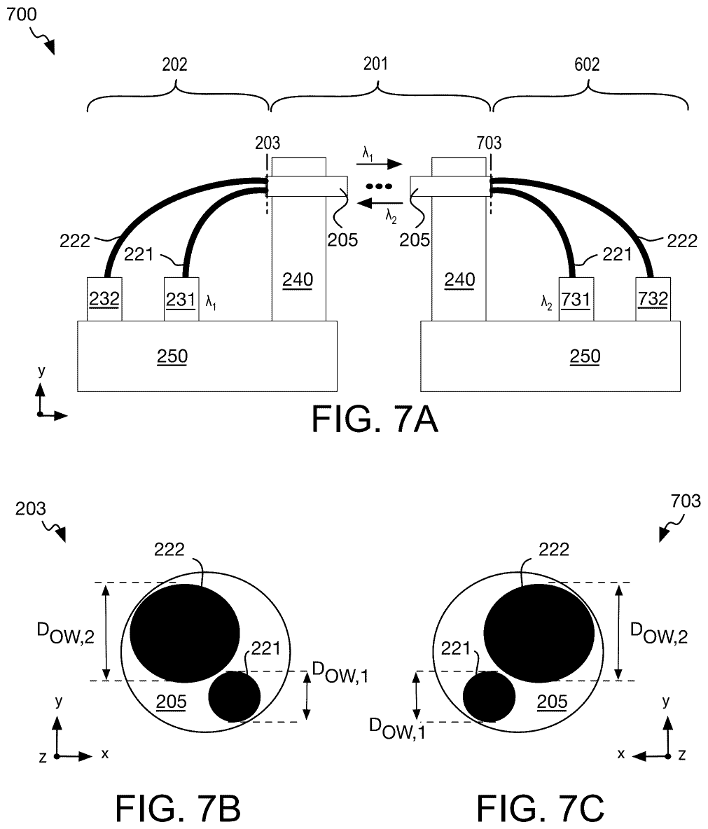

As noted above, in addition to multiplexing an optical fiber to either a plurality of emitters or a plurality of detectors, an optical fiber may be similarly multiplexed to emitter and photodetector pairs and such architectures are well-suited to bidirectional data links. FIG. 7A is a cross-sectional profile view of a bidirectional optical fiber multiplexing system 700, in accordance with some embodiments. In system 700, reference numbers previously introduced are retained for elements that may have any of the characteristics as previously described.

System 700 includes an optical fiber length 201 with a first fiber end face 203 that is coupled through multiplexed optical wire fiber termination 202 to a first optical device 231 and a second optical device 232. In exemplary embodiments, optical device 231 is a first emitter with a first emission center wavelength of λ₁ and optical device 232 is a first detector. Together, optical devices 231 and 232 are operable as a first bidirectional optical transceiver. Optical fiber length 201 has a second fiber end face 703 that is coupled through multiplexed optical wire fiber termination 602 to optical devices 731 and 732, which are similarly operable as a second bidirectional optical transceiver.

In exemplary embodiments, optical device 731 is a first emitter with a second emission center wavelength of λ₂ and optical device 732 is a second detector. Optical device 731 may be substantially the same as optical device 231 (e.g., both VCSELs), or may have a different emitter architecture than optical device 231 (e.g., one being a VCSEL and the other a μLED). In some exemplary embodiments, center wavelengths λ₁ and λ₂ are both in the IR band (e.g., 850 and 880, respectively). For embodiments where detectors 232 and 732 both have broadband device architectures, the two detectors may have substantially the same responsivity. For example, neither detector 232 or detector 732 need be wavelength selective. In other embodiments, for example where detectors 232 and 732 have narrow band architectures, detector 232 may be tuned to have a peak responsivity for a first band comprising λ₂ while detector 732 may be tuned to have a peak responsivity for a second band comprising λ₁.

Optical wire fiber termination 602 may be substantially the same as optical wire fiber termination 202 and includes a set or pair of optical wires 221 and 222, which may have any of the characteristics described elsewhere herein. This set of optical wires 221, 222 intersect distinct portions of fiber end face 703, for example in substantially the same manner as the set of optical wires 221, 222 comprising fiber termination 202. Fiber end face 703 may have substantially the same characteristics (e.g., fiber diameter, shape, flatness, etc.) as fiber end face 203.

As noted elsewhere herein, optical wire cross-sections may vary between wires that interface with a same fiber end face. FIG. 7B is a cross-sectional view through fiber end face 203, in accordance with some embodiments. FIG. 7C is a cross-sectional view through fiber end face 703, in accordance with some further embodiments. To reduce coupling losses, detector-coupled optical wires 222 overlap, or intersect, larger portions of end face 203 and end face 703 than emitter-coupled optical wires 221 overlap. In the illustrated examples, optical wires 222 have a wire diameter D_{ow,2} that is at least 30% larger than wire diameter D_{ow,1} of optical wires 221.

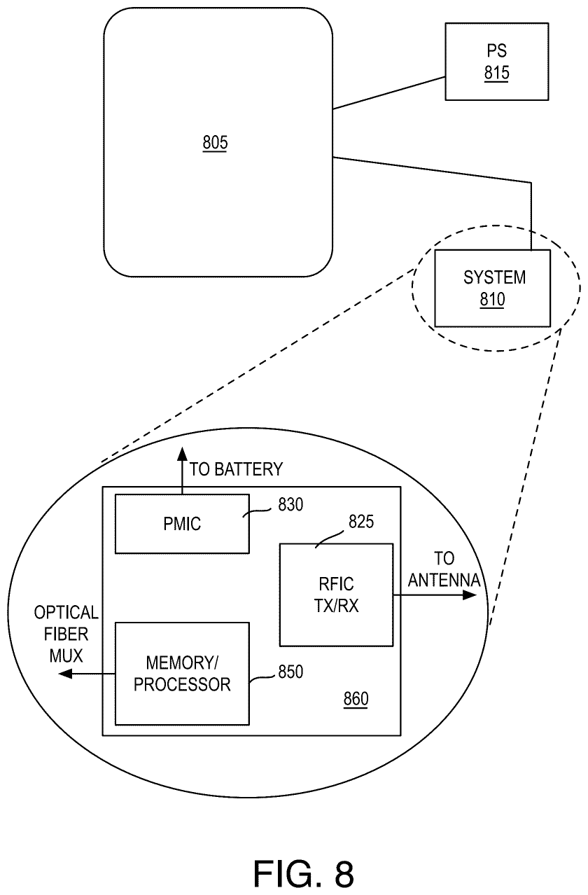

The photonic device assemblies and systems described herein may be implemented in a wide variety of applications and platforms. FIG. 8 illustrates a mobile computing or data server platform 805 employing an optical link with multiplexed optical wire fiber termination, for example as described elsewhere herein. Platform 805 may be any commercial server, for example including any number of high-performance computing platforms disposed within a rack and networked together for electronic data processing. The platform 805 may also be any portable device configured for each of electronic data display, electronic data processing, wireless electronic data transmission, or the like. For example, the platform 805 may be any of a tablet, a smart phone, laptop computer, etc., and may include an integrated or disintegrated system 810, and a power supply 815.

As illustrated in the expanded view, a package substrate 860 is coupled to one or more of a power management integrated circuit (PMIC) 830 or RF (wireless) integrated circuit (RFIC) 825 including a wideband RF (wireless) transmitter and/or receiver. PMIC 830 may perform battery power regulation, DC-to-DC conversion, etc., and has an input coupled to power supply 815 and an output providing a current supply to other functional modules. RFIC 825 has an output coupled to an antenna (not shown) to implement any of a number of wireless standards or protocols, including but not limited to Wi-Fi (IEEE 802.11 family), WiMAX (IEEE 802.18 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, and beyond.

Integrated system 810 further comprises a memory and/or process 850, one or more of which are coupled to an optical data link comprising optical fiber MUX 300 to transmit and/or receive optical communications through an optical wire multiplexed fiber, for example as described elsewhere herein.

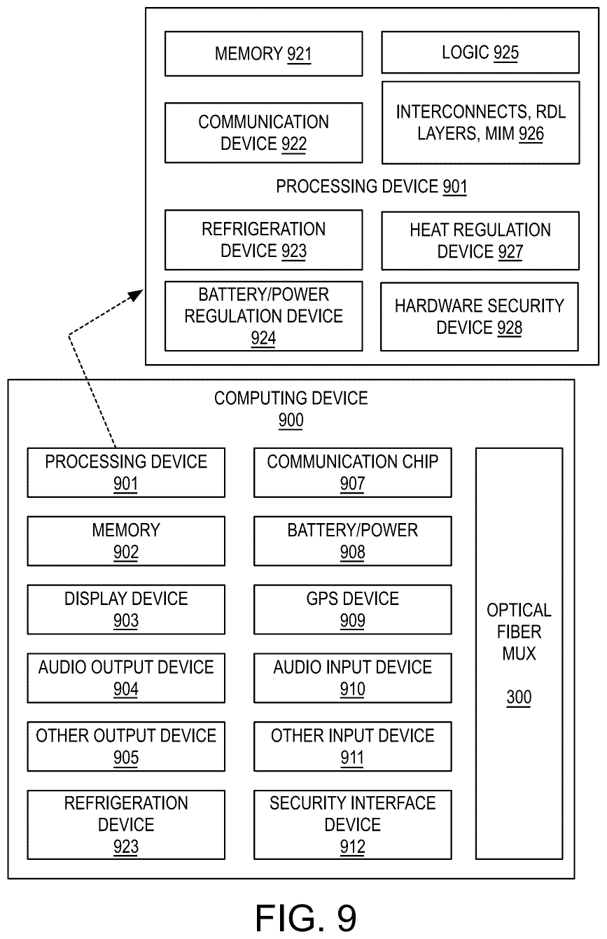

FIG. 9 is a block diagram of a cryogenically cooled computing device 900 in accordance with some embodiments. For example, one or more components of computing device 900 may include any of the optical devices or fiber multiplexing structures discussed elsewhere herein. A number of components are illustrated in FIG. 9 as included in computing device 900, but any one or more of these components may be omitted or duplicated, as suitable for the application. In some embodiments, some of the components included in computing device 900 may be attached to one or more printed circuit boards (e.g., a motherboard). In some embodiments, various ones of these components may be fabricated onto a single system-on-a-chip (SoC) die or implemented with a disintegrated plurality of chiplets or tiles packaged together. Additionally, in various embodiments, computing device 900 may not include one or more of the components illustrated in FIG. 9, but computing device 900 may include interface circuitry for coupling to the one or more components. For example, computing device 900 may not include a display device 903, but may include display device interface circuitry (e.g., a connector and driver circuitry) to which display device 903 may be coupled.

Computing device 900 may include a processing device 901 (e.g., one or more processing devices). As used herein, the term processing device or processor indicates a device that processes electronic data from registers and/or memory to transform that electronic data into other electronic data that may be stored in registers and/or memory. Processing device 901 may include a memory 921, a communication device 922, a refrigeration/active cooling device 923, a battery/power regulation device 924, logic 925, interconnects 926, a heat regulation device 927, and a hardware security device 928.

Processing device 901 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

Processing device 901 may include a memory 902, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, processing 901 shares a package with memory 902. This memory may be used as cache memory and may include embedded dynamic random-access memory (eDRAM) or spin transfer torque magnetic random-access memory (STT-M RAM).

Computing device 900 may include a heat regulation/refrigeration device 923. Heat regulation/refrigeration device 923 may maintain processing device 901 (and/or other components of computing device 900) at a predetermined low temperature during operation. This predetermined low temperature may be any temperature discussed elsewhere herein.

In some embodiments, computing device 900 may include a communication chip 907 (e.g., one or more communication chips). For example, the communication chip 907 may be configured for managing wireless communications for the transfer of data to and from computing device 900. The term “wireless” and its derivatives may be used to describe circuits, devices, systems, methods, techniques, communications channels, etc., that may communicate data through the use of modulated electromagnetic radiation through a nonsolid medium.

Communication chip 907 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. Communication chip 907 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. Communication chip 907 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication chip 907 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication chip 907 may operate in accordance with other wireless protocols in other embodiments. Computing device 900 may include an optical data link comprising optical fiber MUX 300 to transmit and/or receive optical communications through an optical wire multiplexed fiber, for example as described elsewhere herein.

In some embodiments, communication chip 907 may manage wired communications, such as electrical, optical, or any other suitable communication protocols (e.g., the Ethernet). As noted above, communication chip 907 may include multiple communication chips. For instance, a first communication chip 907 may be dedicated to shorter-range wireless communications such as Wi-Fi or Bluetooth, and a second communication chip 907 may be dedicated to longer-range wireless communications such as GPS, EDGE, GPRS, CDMA, WiMAX, LTE, EV-DO, or others. In some embodiments, a first communication chip 907 may be dedicated to wireless communications, and a second communication chip 907 may be dedicated to wired communications.

Computing device 900 may include battery/power circuitry 908. Battery/power circuitry 908 may include one or more energy storage devices (e.g., batteries or capacitors) and/or circuitry for coupling components of computing device 900 to an energy source separate from computing device 900 (e.g., AC line power).

Computing device 900 may include a display device 903 (or corresponding interface circuitry, as discussed above). Display device 903 may include any visual indicators, such as a heads-up display, a computer monitor, a projector, a touchscreen display, a liquid crystal display (LCD), a light-emitting diode display, or a flat panel display, for example.

Computing device 900 may include an audio output device 904 (or corresponding interface circuitry, as discussed above). Audio output device 904 may include any device that generates an audible indicator, such as speakers, headsets, or earbuds, for example.

Computing device 900 may include an audio input device 910 (or corresponding interface circuitry, as discussed above). Audio input device 910 may include any device that generates a signal representative of a sound, such as microphones, microphone arrays, or digital instruments (e.g., instruments having a musical instrument digital interface (MIDI) output).

Computing device 900 may include a global positioning system (GPS) device 909 (or corresponding interface circuitry, as discussed above). GPS device 909 may be in communication with a satellite-based system and may receive a location of computing device 900, as known in the art.

Computing device 900 may include another output device 905 (or corresponding interface circuitry, as discussed above). Examples include an audio codec, a video codec, a printer, a wired or wireless transmitter for providing information to other devices, or an additional storage device.

Computing device 900 may include another input device 911 (or corresponding interface circuitry, as discussed above). Examples may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 900 may include a security interface device 912. Security interface device 912 may include any device that provides security measures for computing device 900 such as intrusion detection, biometric validation, security encode or decode, managing access lists, malware detection, or spyware detection.

Computing device 900, or a subset of its components, may have any appropriate form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that practice of the disclosed techniques and architectures is not limited to the embodiments so described but can be modified and altered without departing from the scope of the appended claims. For example, the above embodiments may include specific combinations of features as further provided below.

In first examples, a photonic device assembly comprises a first optical device and a second optical device, both coupled to a substrate. The assembly comprises an optical fiber coupled to the substrate, wherein an end face of the optical fiber has a cross-sectional core area associated with a core diameter of the optical fiber. The assembly comprises a first optical waveguide having a first end coupled to the first optical device and a second end coupled to the end face of the optical fiber through a first portion of the cross-sectional core area of the optical fiber. The assembly comprises a second optical waveguide having a first end coupled to the second optical device and a second end coupled to the end face of the optical fiber through a second portion of the cross-sectional core area of the optical fiber.

In second examples, for any of the first examples the first optical device comprises an emitter to output at a first center wavelength or a photodetector responsive to the first center wavelength. The second optical device comprises an emitter to output at a second center wavelength or a photodetector responsive to the second center wavelength. The second center wavelength is different than the first center wavelength by at least 5 nm.

In third examples, for any of the second examples the first optical device comprises an emitter to output at the first center wavelength. The second optical device comprises an emitter to output at the second center wavelength, and the first center wavelength and the second center wavelength are both within the 850 nm-940 nm band.

In fourth examples, for any of the second examples the first optical device comprises a semiconductor photodetector responsive to the first center wavelength. The second optical device comprises a semiconductor photodetector responsive to the second center wavelength, and the first center wavelength and the second center wavelengths are within the 850 nm-940 nm band.

In fifth examples, for any of the second examples the first optical device comprises an emitter to output at the first center wavelength. The second optical device comprises a semiconductor photodetector responsive to the second center wavelength. The first center wavelength and the second center wavelengths are within the 850 nm-940 nm band.

In sixth examples, for any of the first through fifth examples the first portion of the cross-sectional core area of the optical fiber is smaller than the second portion of the cross-sectional core area of the optical fiber.

In seventh examples, for any of the first through sixth examples the optical fiber comprises a glass core having the cross-sectional core area, and the first optical wire and the second optical wire comprise a polymer material.

In eighth examples, for any of the first through seventh examples the cross-sectional core area is associated with a core diameter of no more than approximately 62 μm. The first portion of the cross-sectional core area of the optical fiber has a diameter of no more than 25 μm, and the second portion of the cross-sectional core area of the optical fiber has a diameter of no more than 25 μm.

In ninth examples, for any of the eighth examples the first optical device is an emitter having an emission aperture of a first diameter, smaller than 25 μm and the first end of the first optical waveguide has a diameter larger than the first diameter.

In tenth examples, for any of the eighth examples the first optical device is a photodetector having a collection aperture of a first diameter, smaller than 25 μm, and wherein the first end of the first optical waveguide has a diameter smaller than the first diameter.

In eleventh examples, for any of the eighth examples the first optical device is a photodetector comprising a wavelength filter.

In twelfth examples, for any of the first through eleventh examples the assembly comprises one to sixteen additional optical devices coupled to the substrate, and one to sixteen additional optical waveguides. Each of the additional optical waveguides have a first end coupled to a corresponding one of the additional optical devices and a second end coupled to the end face of the optical fiber through a corresponding portion of the cross-sectional core area of the optical fiber.

In thirteenth examples, for any of the first through twelfth examples the optical fiber is one of a plurality of optical fibers coupled the substrate. Each of the optical fibers has a cross-sectional core area associated with a core diameter of the corresponding optical fiber. The first and second optical devices are one pair of a plurality of optical device pairs, each of the optical device pairs coupled to separate portions of the cross-section core area of a corresponding one of the optical fibers.

In fourteenth examples, an optical fiber multiplexing system comprises a first fiber array unit comprising first ends of N fibers. The system comprises a first array of M first optical devices. The first optical devices comprise N first optical device groups further comprising two or more first optical devices. Each of the first optical devices within one of the first optical device groups is coupled to an optical waveguide that intersects a portion of a first end of a corresponding one of the fibers.

In fifteenth examples, for any of the fourteenth examples each of the first optical device groups comprise an emitter to output at a first center wavelength and a photodetector responsive to a second center wavelength, different than the first center wavelength.

In sixteenth examples, for any of the fifteenth examples the system further comprises a second fiber array comprising second ends of the N fibers and a second array of M second optical devices. The second optical devices comprise N second optical device groups further comprising two or more second optical devices. Each of second optical devices within one of the second optical device groups is coupled to an optical wire that intersects a portion of a second end of a corresponding one of the fibers.

In seventeenth examples, for any of the sixteenth examples each of the second optical device groups comprise an emitter to output at the second center wavelength and a photodetector responsive to the first center wavelength.

In eighteenth examples, a method comprises attaching an optical fiber core to a substrate, attaching two or more optical devices to the substrate. The method comprises printing, within free space, a first optical waveguide spanning a first distance between a first of the optical devices to a first portion of an end of the optical fiber core. The method comprises printing, within free space, a second optical waveguide spanning a second distance between a second of the optical devices to a second portion of the end of the optical fiber core.

In nineteenth examples, for any of the eighteenth examples attaching the optical fiber core to the substrate comprises attaching a fiber array unit to the substrate, the fiber array unit orienting the optical fiber core to be substantially parallel to a plane of the substrate. Attaching the optical devices to the substrate comprises attaching a first vertical-cavity surface-emitting laser (VCSEL) and attaching a second VCSEL or a vertical photodetector. Printing the first optical waveguide and the second optical waveguide comprises extruding a polymerizing precursor from a print head as the print head traverses a distance between each of the optical devices and the corresponding portions of the end of the optical fiber core.

In twentieth examples, for any of the nineteenth examples the first VCSEL emits at a first center frequency, the second VCSEL emits at a second center frequency, or the vertical photodetector is responsive to the second center frequency.

However, the above embodiments are not limited in this regard, and, in various implementations, the above embodiments may include the undertaking of only a subset of such features, undertaking a different order of such features, undertaking a different combination of such features, and/or undertaking additional features than those features explicitly listed. The scope of the disclosed techniques and architectures should therefore be determined with reference to the appended claims, along with the full scope of equivalents to which such claims are entitled.

What is claimed is:

1. A photonic device assembly, comprising:
a first optical device and a second optical device, both coupled to a surface of a substrate;
an optical fiber coupled to the substrate, wherein an end face of the optical fiber has a cross-sectional core area associated with a core diameter of the optical fiber;
a first optical waveguide having a first end coupled to the first optical device and a second end coupled to the end face of the optical fiber through a first portion of the cross-sectional core area of the optical fiber; and
a second optical waveguide having a first end coupled to the second optical device and a second end coupled to the end face of the optical fiber through a second portion of the cross-sectional core area of the optical fiber, wherein at least a partial length of the first optical waveguide is suspended above the surface of the substrate.

2. The photonic device assembly of claim 1, wherein:
substantially all of the length of the first and second optical waveguides between the optical fiber and the optical devices is spaced apart from the surface of the substrate;
the first optical device comprises an emitter to output at a first center wavelength or a photodetector responsive to the first center wavelength;
the second optical device comprises an emitter to output at a second center wavelength or a photodetector responsive to the second center wavelength; and
the second center wavelength is different than the first center wavelength by at least 5 nm.

3. The photonic device assembly of claim 2, wherein:
the first optical device comprises an emitter to output at the first center wavelength;
the second optical device comprises an emitter to output at the second center wavelength; and
the first center wavelength and the second center wavelength are both within the 850 nm-940 nm band.

4. The photonic device assembly of claim 2, wherein:
the first optical device comprises a semiconductor photodetector responsive to the first center wavelength;
the second optical device comprises a semiconductor photodetector responsive to the second center wavelength; and
the first center wavelength and the second center wavelengths are within the 850 nm-940 nm band.

5. The photonic device assembly of claim 2, wherein:
the first optical device comprises an emitter to output at the first center wavelength;
the second optical device comprises a semiconductor photodetector responsive to the second center wavelength; and
the first center wavelength and the second center wavelengths are within the 850 nm-940 nm band.

6. The photonic device assembly of claim 5, wherein the first portion of the cross-sectional core area of the optical fiber is smaller than the second portion of the cross-sectional core area of the optical fiber.

7. The photonic device assembly of claim 1, wherein:
the optical fiber comprises a glass core having the cross-sectional core area; and
the first optical waveguide and the second optical waveguide comprise a polymer material.

8. The photonic device assembly of claim 7, wherein:
the cross-sectional core area is associated with a core diameter of no more than approximately 62 μm;
the first portion of the cross-sectional core area of the optical fiber has a diameter of no more than 25 μm; and
the second portion of the cross-sectional core area of the optical fiber has a diameter of no more than 25 μm.

9. The photonic device assembly of claim 8, wherein the first optical device is an emitter having an emission aperture of a first diameter, smaller than 25 μm and wherein the first end of the first optical waveguide has a diameter larger than the first diameter.

10. The photonic device assembly of claim 8, wherein the first optical device is a photodetector having a collection aperture of a first diameter, smaller than 25 μm, and wherein the first end of the first optical waveguide has a diameter smaller than the first diameter.

11. The photonic device assembly of claim 8, wherein the first optical device is a photodetector comprising a wavelength filter.

12. The photonic device assembly of claim 1, further comprising:
one to sixteen additional optical devices coupled to the substrate; and
one to sixteen additional optical waveguides, each of the additional optical waveguides having a first end coupled to a corresponding one of the additional optical devices and a second end coupled to the end face of the optical fiber through a corresponding portion of the cross-sectional core area of the optical fiber, and each of the additional optical waveguides suspended above a surface of the substrate.

13. The photonic device assembly of claim 1, wherein:
the optical fiber is one of a plurality of optical fibers coupled the substrate, wherein each of the optical fibers has a cross-sectional core area associated with a core diameter of the corresponding optical fiber; and
the first and second optical devices are one pair of a plurality of optical device pairs, each of the optical device pairs coupled to separate portions of the cross-section core area of a corresponding one of the optical fibers.

14. An optical fiber multiplexing system, comprising:
a first fiber array unit comprising first ends of N fibers;
a first array of M first optical devices, wherein the first optical devices comprise N first optical device groups further comprising two or more first optical devices, and wherein each of the first optical devices within one of the first optical device groups is coupled to an optical wire that intersects a portion of a first end of a corresponding one of the fibers.

15. The optical fiber multiplexing system of claim 14, wherein each of the first optical device groups comprise an emitter to output at a first center wavelength and a photodetector responsive to a second center wavelength, different than the first center wavelength.

16. The optical fiber multiplexing system of claim 14, further comprising:
a second fiber array comprising second ends of the N fibers;
a second array of M second optical devices, wherein the second optical devices comprise N second optical device groups further comprising two or more second optical devices, and wherein each of second optical devices within one of the second optical device groups is coupled to an optical wire that intersects a portion of a second end of a corresponding one of the fibers.

17. The optical fiber multiplexing system of claim 16, wherein each of the second optical device groups comprise an emitter to output at the second center wavelength and a photodetector responsive to the first center wavelength.

18. A method comprising:
attaching an optical fiber to a substrate;
attaching two or more optical devices to the substrate;
printing, within free space, a first optical waveguide spanning a first distance between a first of the optical devices to a first portion of an end of the optical fiber; and
printing, within free space, a second optical waveguide spanning a second distance between a second of the optical devices to a second portion of the end of the optical fiber.

19. The method of claim 18, wherein:
attaching the optical fiber core to the substrate comprises attaching a fiber array unit to the substrate, the fiber array unit orienting the optical fiber to be substantially parallel to a plane of the substrate;
attaching the optical devices to the substrate comprises attaching a first vertical-cavity surface-emitting laser (VCSEL) and attaching a second VCSEL or a vertical photodetector; and
printing the first optical waveguide and the second optical waveguide comprises extruding a polymerizing precursor from a print head as the print head traverses a distance between each of the optical devices and the corresponding portions of the end of the optical fiber.

20. The method of claim 19, wherein the first VCSEL emits at a first center frequency, the second VCSEL emits at a second center frequency, or the vertical photodetector is responsive to the second center frequency.
